(19) United States
(12) Patent Application Publication
(10) Pub. No.: US 2005/0289645 A1
(43) Pub. Date: Dec. 29, 2005

(54) Image processing device and program

(75) Inventor: Kiyoshi Hori, Osaka (JP)

Correspondence Address: SHINJYU GLOBAL IP COUNSELORS, LLP, 1233 20TH STREET, NW, SUITE 700, WASHINGTON, DC, 20036-2680, US

(73) Assignee: Kyocera Mita Corporation, Osaka (JP)

(21) Appl. No.: 10/875,808

(22) Filed: Jun. 25, 2004

(51) Int. Cl. G06F 15/16

(52) U.S. Cl. 726/7

(57) ABSTRACT

In a password entry screen in which a password that has been entered is displayed only as solid black circles (●) or letter Xs (X), or inverted to a black display, for example, when entering characters using a 10-key it is not possible to ascertain whether there has been an incorrect key entry or whether the password itself is incorrect. When verifying a password that has been entered, if only one character of the password is incorrect, then it is determined that an incorrect key entry has occurred and this is indicated to the user, whereas if two or more characters are wrong, then it is determined that the password itself is incorrect and this is indicated to the user, and thus a user can easily respond to a case where the password that has been entered is not accepted, allowing the foregoing problems to be solved.

### FIELD OF THE INVENTION

The present invention relates to image processing devices having a password entry screen that is displayed before users and administrators may access a screen that is protected for security reasons, and programs for controlling such image processing devices.

### BACKGROUND ART

In conventional image processing devices, screens that are not used by all users, such as the initial settings screens, section management screens, and service provision screens, are protected by password, preventing third parties from accessing accounting information, personal information, or other data that are stored. A password entry screen is displayed when switching to a screen protected by password or when calling up images, and into this password entry screen a user enters his password to be verified. When the result of this verification is that the password is a match, it becomes possible to switch to the desired screen or to retrieve desired data. With the password displayed on this password screen, however, there is a risk that the password may be misused if seen by other persons. Accordingly, as disclosed in Japanese Published Patent Application No. 2001-337734, the safety of confidential information is increased by masking the password by inverting the fields to which the password has been entered to display only black or white, or showing solid black circles (●) or letter Xs (X) in place of characters or numbers.

With this technology, however, the password that is entered is not displayed, and thus when verified, if the password is not a match, then it is not possible to ascertain immediately whether this is due to an incorrect key entry or whether this is because the password itself is incorrect. In particular, when employing key entry means in which a plurality of characters are assigned to a single key, and continuously operating this one key to toggle between a plurality of characters to select and enter one or more proposed characters, the password itself will become complicated. Thus, one must manually operate this one key, there will be many incorrect key entries, and it is very important to know whether a failed password is the result of a simple incorrect key entry or that the password itself is incorrect. Moreover, when only a part of the password is incorrectly entered, reentering the password from the beginning is very arduous and time-consuming. It is an object of the present invention to solve these problems.

### SUMMARY OF THE INVENTION

To solve the foregoing problems, an image processing device according to a first aspect of the present invention is an image processing device having key entry means for entering a password and a password entry screen for displaying a screen protected by password, the image processing device including entered password display means for controlling display of the password that is entered to the password entry screen, password verification means for performing verification of a password that has been entered, and misentry display means which, if there is a misentry in the password that has been entered and a number of characters of the misentry is equal to or less than a number of allowable misentries, indicates on the password entry screen that there is an incorrect key entry in the password, and if the number of characters that have been misentered is greater than a number of allowable misentries, indicates on the password entry screen that the password is incorrect.

In a second aspect of the present invention, the image processing device according to the first aspect further includes password reentry display means which, if there is a misentry in a password that has been entered, and a number of characters of the misentry is equal to or less than a number of allowable misentries, displays a screen through which it is possible to reenter only the characters that have been misentered, and if the number of characters that have been misentered is greater than a number of allowable misentries, displays a screen in which the entire entered password has been cleared to allow the password to be entered from the beginning.

In a third aspect of the present invention, in the image processing device according to the first aspect, the entered password display means conceals the password that has been entered to the password entry screen.

In a fourth aspect of the present invention, in the image processing device according to the first aspect, the number of allowable misentries is one.

An image processing device according to a fifth aspect of the present invention is an image processing device having key entry means for entering a password and a password entry screen for displaying a screen protected by password, and includes entered password display means for controlling display of the password that is entered to the password entry screen, password verification means for performing verification of a password that has been entered, and password reentry display means which, if there is a misentry in the password that has been entered and a number of characters of the misentry is equal to or less than a number of allowable misentries, displays a screen through which it is possible to reenter only the characters that have been misentered, and if the number of characters that have been misentered is greater than a number of allowable misentries, displays a screen in which the entire entered password has been cleared to allow the password to be reentered from the beginning.

In a sixth aspect of the present invention, in the image processing device according to the fifth aspect, the entered password display means conceals the password that has been entered to the password entry screen.

In a seventh aspect of the present invention, in the image processing device according to the sixth aspect, the number of allowable misentries is one.

A program according to an eighth aspect of the present invention is for causing a computer to function, with respect to an image processing device having key entry means for entering a password and a password entry screen for displaying a screen protected by password, as entered password display means for controlling display of the password that is entered to the password entry screen, password verification means for performing verification of a password that has been entered, and misentry display means which, if there is a misentry in the password that has been entered and a number of characters of the misentry is equal to or less than a number of allowable misentries, indicates on the password entry screen that there is an incorrect key entry in the password, and if the number of characters that have been misentered is greater than a number of allowable misentries, indicates on the password entry screen that the password is incorrect.

In a ninth aspect of the present invention, in the program according to the eighth aspect, the computer is made to function as password reentry display means which, if there is a misentry in the password that has been entered and a number of characters of the misentry is equal to or less than a number of allowable misentries, displays a screen through which it is possible to reenter only the characters that have been misentered, and if the number of characters that have been misentered is greater than a number of allowable misentries, displays a screen in which the entire entered password has been cleared to allow the password to be entered from the beginning.

In a tenth aspect of the present invention, in the program according to the eighth aspect, the entered password display means conceals the password that has been entered to the password entry screen.

In a eleventh aspect of the present invention, in the program according to the eighth aspect, the number of allowable misentries is one.

A program according to a twelfth aspect of the present invention is for causing a computer to function, with respect to an image processing device having key entry means for entering a password and a password entry screen for displaying a screen protected by password, as entered password display means for controlling display of the password that is entered to the password entry screen, password verification means for performing verification of a password that has been entered, and password reentry display means which, if there is a misentry in the password that has been entered and a number of characters of the misentry is equal to or less than a number of allowable misentries, displays a screen through which it is possible to enter only the characters that have been misentered, and if the number of characters that have been misentered is greater than a number of allowable misentries, displays a screen in which the entire entered password has been cleared to allow the password to be reentered from the beginning.

In a thirteenth aspect of the present invention, in the program according to the twelfth aspect, the entered password display means conceals the password that has been entered to the password entry screen.

In a fourteenth aspect of the present invention, in the program according to the twelfth aspect, the number of allowable misentries is one.

According to the inventions of the first and eighth aspects, at the time the password is verified if the number of misentered characters of a password that has been entered is small, there is a high probability that this is the result of an incorrect key entry. If the number of characters that have been misentered is large, then there is a high probability that the user is not aware that the password has been changed or that he is recalling a different password. Accordingly, by selectively employing a display indicating that there has been a simple incorrect key entry and a display indicating that the password itself is mistaken, based on the results of a comparison between the number of allowable misentered characters that has been determined in advance and the actual number of misentered characters, it is possible to improve the convenience for the user.

According to the inventions of the second and ninth aspects, a screen for reentering the password is displayed in conjunction with the display indicating that there has been a simple incorrect key entry or the display indicating that the password itself is mistaken. Thus this is considerate of the user.

According to the inventions of the fifth and twelfth aspects, at the time the password is verified if the number of misentered characters of a password that has been entered is small, there is a high probability that this is the result of an incorrect key entry. If the number of characters that have been misentered is large, then there is a high probability that the user is not aware that the password has been changed or that he is recalling a different password. Accordingly, in the case of a simple incorrect key entry, based on the results of a comparison between the number of allowable misentered characters that has been determined in advance and the actual number of misentered characters, if only the characters that have been misentered are reentered then it is possible to perform verification again. Thus it is not necessary for the user to perform the bothersome task of reentering the whole password from the beginning, and this increases the convenience for the user.

According to the inventions of the third, sixth, tenth and thirteenth aspects, by masking the password that is entered to the password entry screen by concealing it, it is possible to increase the confidentiality of the password.

According to the inventions of the fourth, seventh, eleventh and fourteenth aspects, the security is increased because the number of allowed misentries is defined as one. That is, if the user remembers the password that should be entered, there will be few input mistakes, and even when there are, these are most likely to be of only a single character. Thus, because it is rare for the user to make an input mistake of two or more characters, by treating such cases as if the password is mistaken as a whole, it is possible to reduce the risk that the password will be misused.

### BRIEF DESCRIPTION OF THE DRAWINGS

FIG. 1 is a block diagram of a multifunction device and peripheral electronic devices adopting the present invention.

FIG. 2 is a control panel of the multifunction device adopting the present invention.

FIG. 3 is the base screen that is displayed on the LCD display portion of the control panel of the multifunction device adopting the present invention.

FIG. 4 is the user function screen (one of the function screens) that is displayed on the LCD display portion of the control panel of the multifunction device adopting the present invention.

FIG. 5 is the functions list screen (one of the function screens) that is displayed on the LCD display portion of the control panel of the multifunction device adopting the present invention.

FIG. 6 is the aggregate screen (one of the function screens) that is displayed by operating the aggregate key on the functions list screen that is displayed on the LCD display portion of the control panel of the multifunction device adopting the present invention.

FIG. 7 is the selection screen of the initial settings screen that is displayed on the LCD display portion of the control panel of the multifunction device adopting the present invention.

FIG. 8 is the password entry screen that is displayed on the LCD display portion of the control panel of the multifunction device adopting the present invention.

FIG. 9 is the copy initial settings screen that is displayed on the LCD display portion of the control panel of the multifunction device adopting the present invention.

FIG. 10 is the 10-key corresponding to the password entry means of the control panel of the multifunction device adopting the present invention.

FIG. 11 shows the transition of the process flow when characters are entered to the password entry screen of the present invention.

FIG. 12 is shows the flow of the processing when a password has been entered on the password entry screen of the present invention.

FIG. 13 is the screen that is displayed on the password entry screen of the present invention when the verification results are that a non-match has occurred.

FIG. 14 is a diagram showing the configuration of the CPU of the multifunction device adopting the present invention.

### DESCRIPTION OF THE PREFERRED EMBODIMENTS

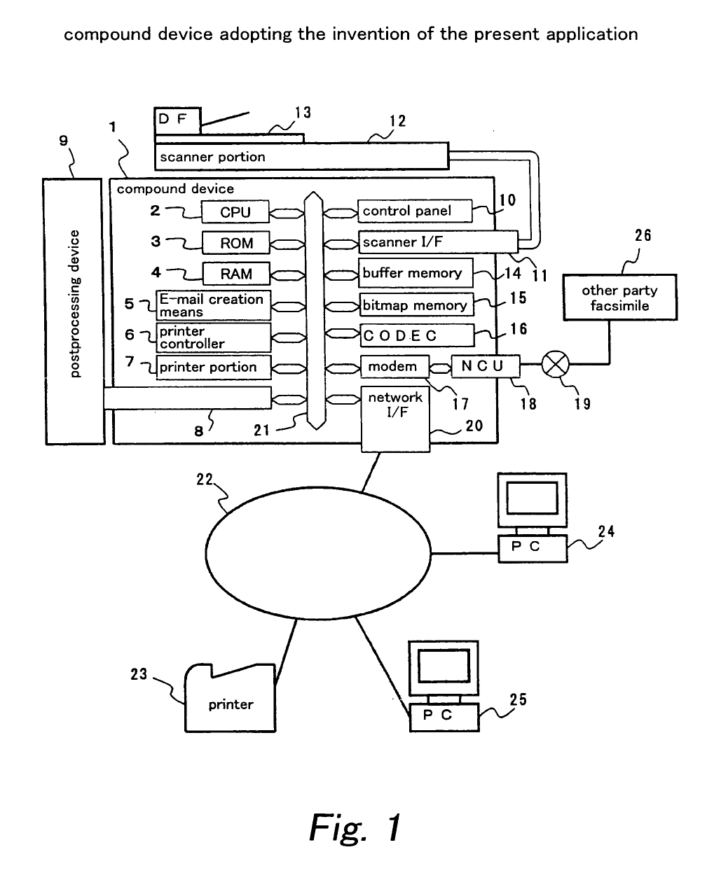

A multifunction device serving as an image processing device adopting the present invention is described below with reference to the schematic diagram of FIG. 1. A multifunction device 1 is a multifunction device having the functions of a copier, printer, facsimile, and scanner, and for example is made of a CPU (central processing unit) 2, a ROM (read-only memory) 3, a RAM (random access memory) 4, an E-mail creation means 5, a printer controller 6, a printer portion 7, a postprocessing device I/F (postprocessing device interface) 8, a postprocessing device 9, a control panel 10, a scanner I/F (scanner interface) 11, a scanner portion 12, a DF (automatic original document feeder) 13, image memory means 14, a bitmap memory 15, a CODEC (coder-decoder) 16, a modem 17, an NCU (network control unit) 18, a public telephone line 19, a network I/F (network interface) 20, a bus 21, and an original document stacking tray 27. The multifunction device 1 is connected to PCs (personal computers) (24, 25) and a printer 23 via a network cable 22.

The E-mail creation means 5 is means for creating electronic mail when data read by the scanner 12 is sent as an attachment for another party that has been registered in advance.

The printer controller 6 performs analysis of print commands (PDL) or job information sent from a connected personal computer and stored in a receiving region of the buffer memory 14, and creates intermediate language information. The intermediate language information is stored in an intermediate language information memory region of the buffer memory 14.

The printer portion 7 sequentially sends image data in use in the bitmap memory 15 to an optical device for writing a latent image such as an LSU or LPH of the image-creation portion of the printer portion 7. The printer portion 7 forms toner images with the image-creation portion and transfers these images to paper sequentially fed and carried from a paper feed cassette, allows the toner images to set, and then discharges the paper.

The postprocessing device 9 performs postprocessing such as stapling and hole punching, and performs compiling such as sorting and grouping, with respect to the printed material that is printed and discharged from the multifunction device 1. The postprocessing device I/F 8 is an interface and a cable for connecting postprocessing device 9 to the multifunction device 1 main unit.

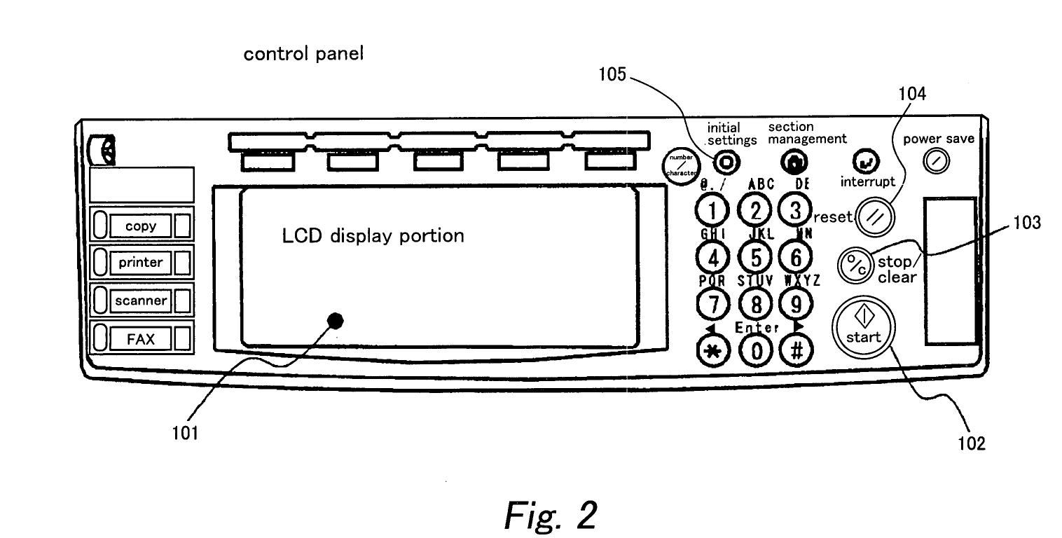

The control panel 10, as shown in FIG. 2, includes a LCD display portion 101, which is a large-sized LCD device, a start key 102, a stop/clear key 103, a reset key 104, and a plurality of control keys such as key entry means (10-key) 106. The start key 102 is a key to start copying, start reading with the scanner, and start facsimile transmission. The stop/clear key 103 is a key for canceling immediately prior settings and interrupting the job. The reset key 104 is for clearing all settings and returning to the base screen from that screen or any other screen that may be displayed on the LCD display portion 101. An initial settings key 105 is a key for switching to a screen for setting the initial settings of the multifunction device, and is described in detail later. There is also the 10-key, an interrupt key, a power save key, and a section management key, and, because this image processing device is a multifunction device, the operation display portion can be switched between the copy function screen, the printer function screen, the facsimile function screen, and the scanner function screen by using a selection key to the left of the control panel 10.

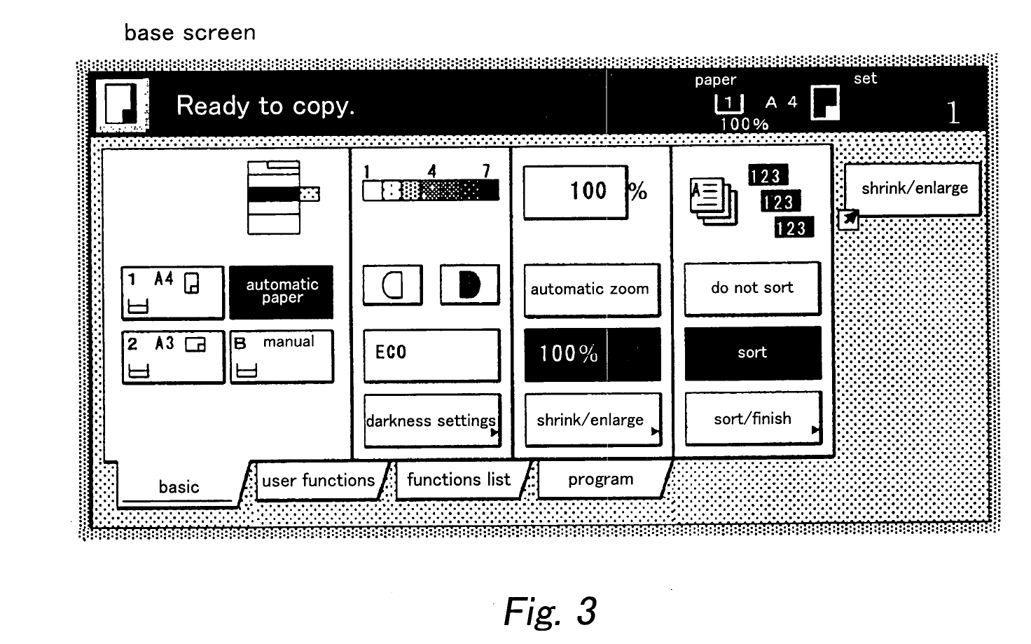

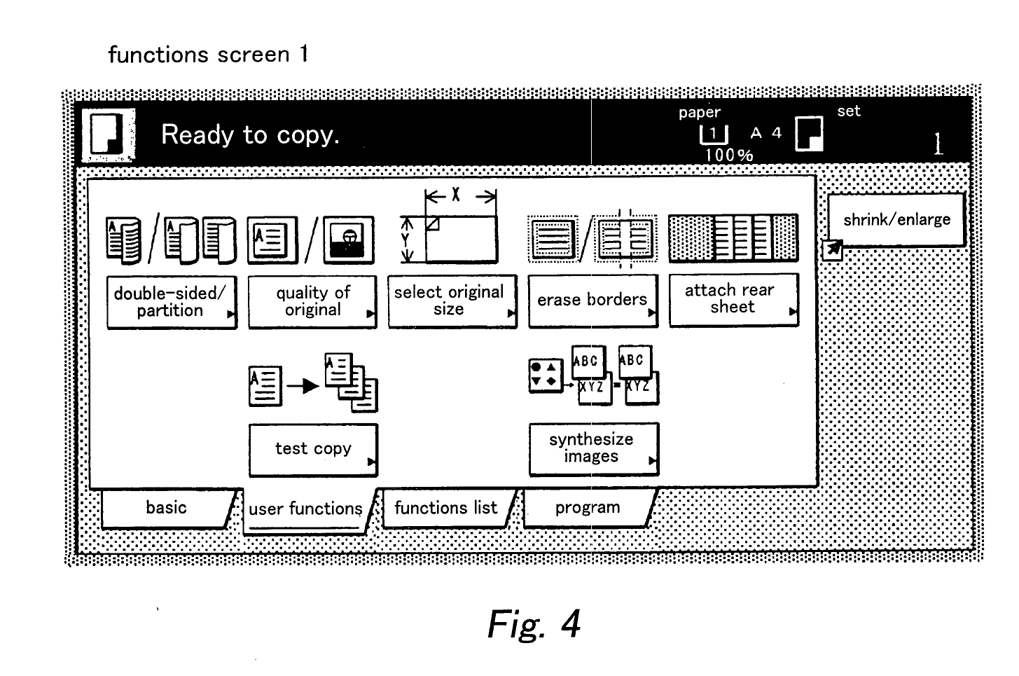

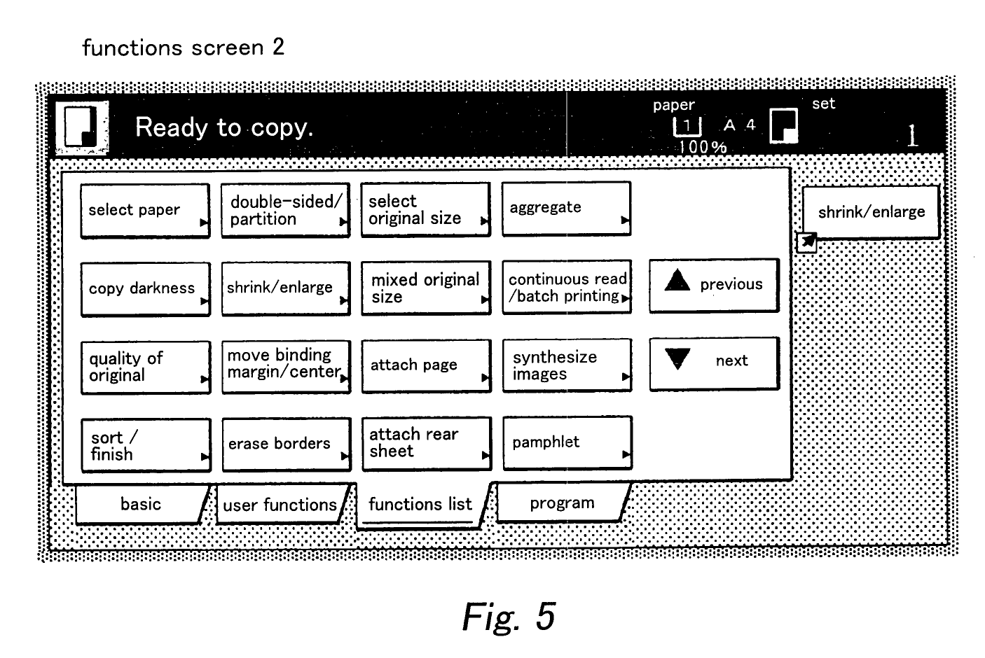

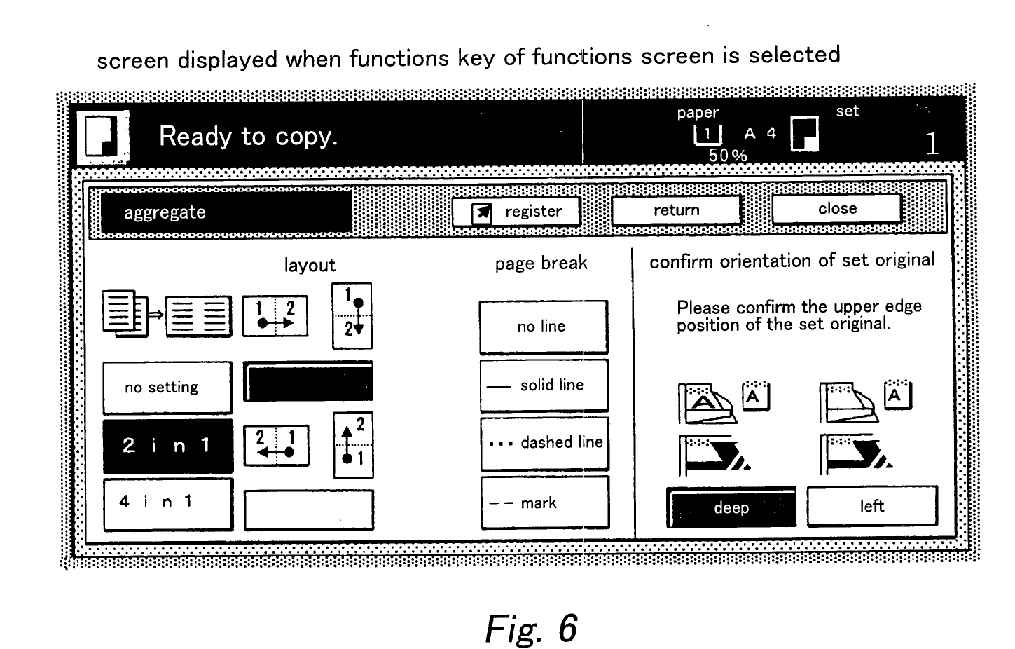

The screens displayed on the LCD display portion 101 include the base screen shown in FIG. 3 and the “user function screen” (one of the function screens) shown in FIG. 4, which is displayed when “user function” is selected from the plurality of tabs at the bottom of the base screen. The “functions list screen” (one of the function screens) shown in FIG. 5 is displayed when the “functions list” tab is selected. The black band display portion at the upper part of the screen, which is displayed in all of these screens, displays the phrase “Ready to copy.” and the selected cassette 1, the zoom factor, and number of sheets that has been set. Also, on the “functions list screen” of FIG. 5 mentioned above, if for example the “aggregate” option on the functions list is selected, then the “aggregate function screen” (one of the function screens) shown in FIG. 6 is displayed.

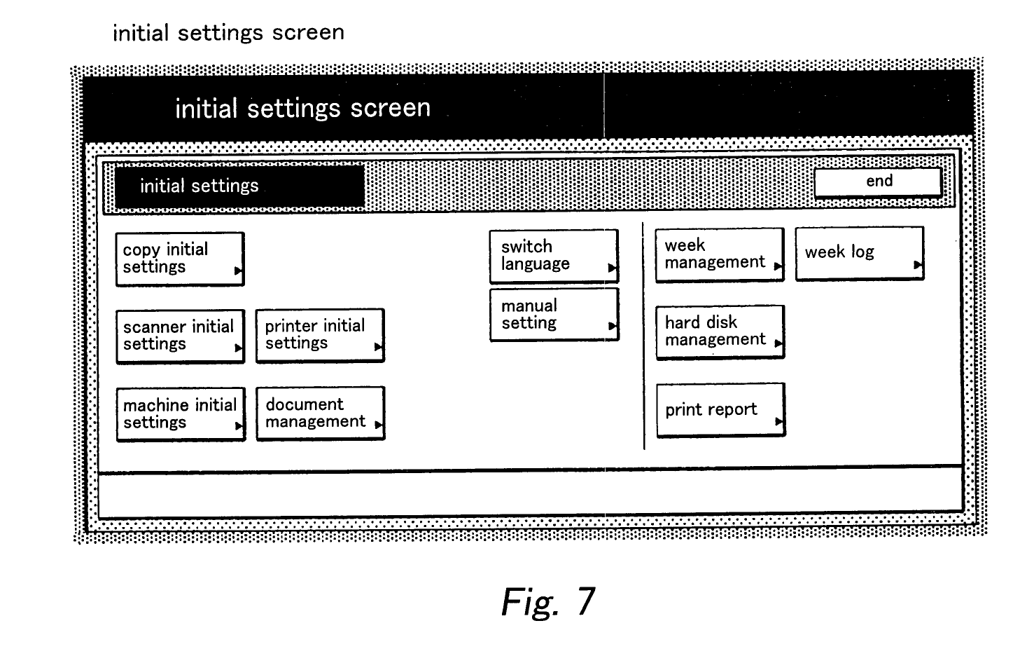

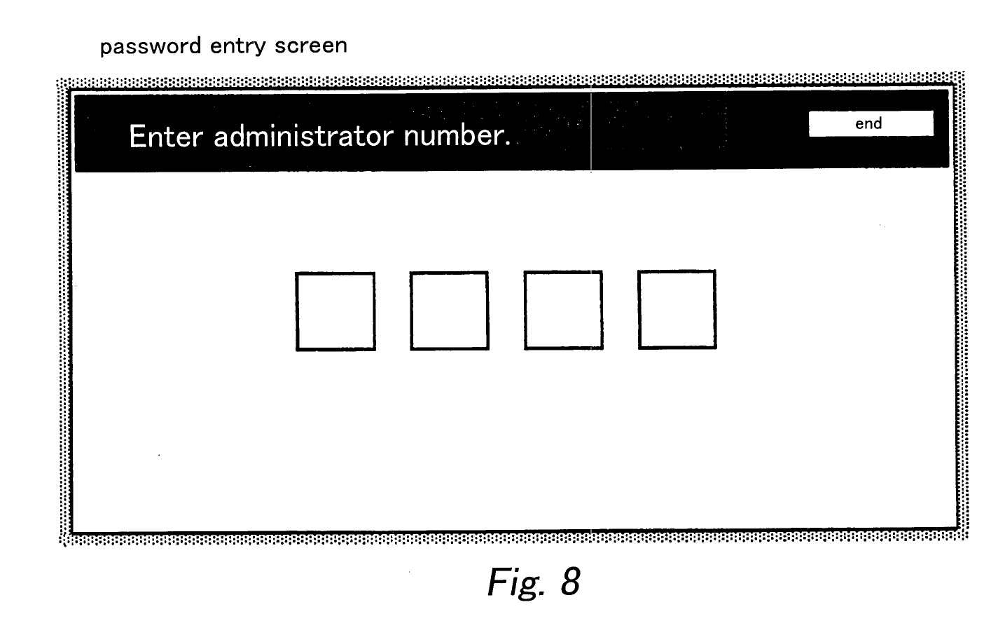

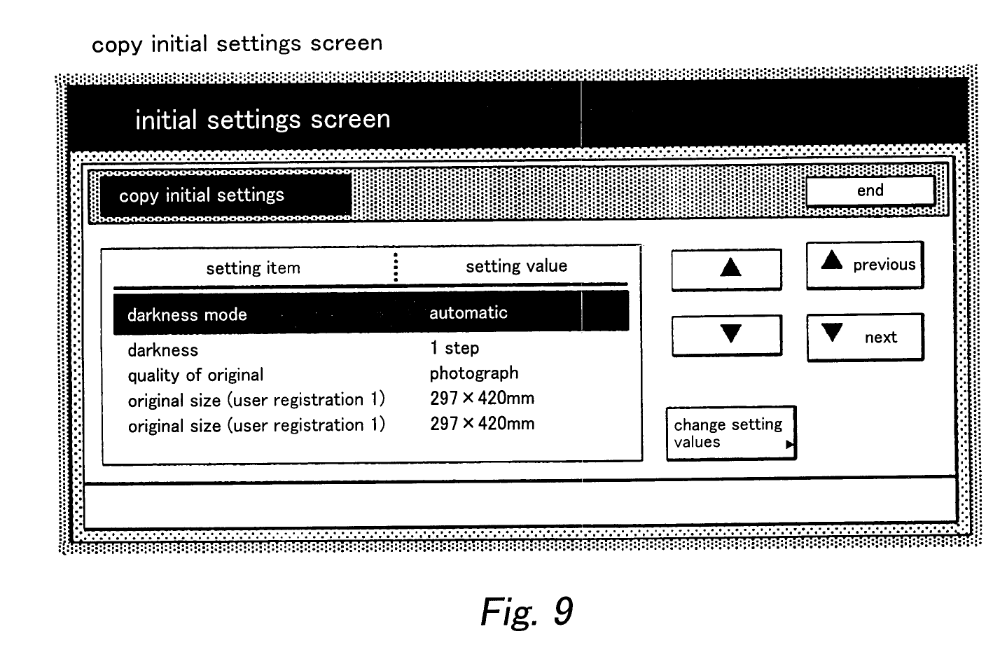

Furthermore, when the initial settings key 105 is operated, an initial settings screen such as that shown in FIG. 7 is displayed on the LCD display portion 101. The initial settings screen is for adjusting the settings when the power is turned on and after all settings have been cleared. When the “copy initial settings” key on the upper left of the initial settings screen is selected an administrator number entry screen such as that shown in FIG. 8 is displayed. This administrator number entry screen corresponds to the password entry screen of the present invention. The manner in which passwords are input is described in detail later. When a password is entered on the administrator number entry screen using the 10-key, the password that is entered is verified, and if it is a match then the screen is switched to the copy initial settings screen shown in FIG. 9.

The scanner I/F 11 is an interface that is connected, via a cable, to the scanner portion 12 disposed on the top of the multifunction device 1 and is for controlling the scanner portion 12 and the DF 13.

The scanner portion 12 irradiates light onto an original document, which is fed one sheet at a time by the DF 13 or one sheet of which is placed on the contact glass, using a halogen lamp or a fluorescent lamp. The scanner portion 12 reads the reflected light with a CCD sensor, converts these analog signals into digital signals through A/D conversion and performs image processing with the image processing portion, and then sends these to the bitmap memory 15, which is at a later stage. The bitmap memory 15 is a means for expanding the image data from the scanner portion 12, the intermediate language information created by analyzing the print commands transferred from a personal computer connected via a network and the like with the printer controller 7, and the image data sent from a facsimile 26 belonging to another via the public telephone line 19, the NCU 18, or the modem 17, using the CODEC 16 as necessary, and developing and holding these as full bitmap image data. The CODEC 16 is also employed for decoding image data in the print data that have been encoded.

In addition to the received image region and the intermediate language region, if performing memory transmission or reserved transmission of a normal memory copy or facsimile, then the buffer memory 14 also encodes the image data read by the scanner portion 12 using the CODEC 16, and stores these. If using the scanner function, then image data read by the scanner portion 12 that has been encoded by the CODEC 16 and stored can be read out from an outside computer. Similarly, it is possible to read from another party's facsimile using the polling function of the facsimile. In recent years there have been many multifunction devices 1 that employ hard disks as image memories with relatively large capacities for image data storage.

The modem 17 is for converting analog signals sent over the public telephone line 19 into digital signals, or alternatively, for converting digital signals into analog signals and sending these over a public telephone line. The modem may perform modulation and demodulation and carry out reception of HDLC frames only, for example. The NCU 18 is for connecting to the public telephone line, switching between facsimile and telephone, sending on-hook signals to the telephone line, and conducting ring detection, for example.

The network I/F 20 is an interface for connecting the multifunction device 1 to a network. Here the network I/F 20 is connected to personal computers (24, 25), a printer 23, and other connection devices that are not shown, via the network cable 22.

The bus 21 is a bus for sending and receiving the various data and signals mentioned above. Separate buses are employed for the image data and for the control signals, but here these are expressed in a simplified manner as a single bus.

The CPU 2 controls the operations and functions of the various components of the multifunction device 1, including the above-described aspects of the multifunction device 1, and executes a print job in accordance with the foregoing conditions and settings. Here, print job refers to the processing by the CPU 2 to control the operations and functions of the various components to obtain printed material corresponding to a series of original documents in accordance with the above conditions and settings. The CPU 2 is also connected to the ROM 3, which stores various programs including the control program of the present invention, and the RAM 4, which for example stores user choice data, settings information, total count data, and various font data.

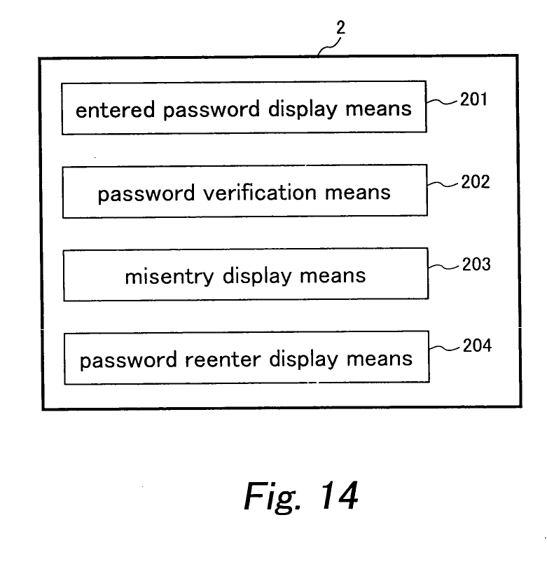

More specifically, in the image processing device of the present invention the CPU 2 is provided with entered password display means 201, password verification means 202, misentry display means 203, and password reentry display means 204, as shown in FIG. 14. These means 201 to 204 are for controlling the operations and functions that serve as features of the image processing device of the present invention. It goes without saying that the CPU 2 controls not only the operations of the foregoing means 201 to 204 but also all the operations of the components of the multifunction device 1.

The entered password display means 201 controls the display of passwords entered through the password entry screen displayed on the LCD display portion 101. The entered password display means 201 also makes the characters of the password indiscernible by, for example, masking each character of the password when it is entered.

The password verification means 202 performs verification of the password that is entered through the key entry means 106 of the control panel 10 on the password entry screen.

If there is a misentry in the password that has been entered and the number of misentered characters is equal to or less than the number of allowable misentries, then the misentry display means 203 indicates on the password entry screen that there has been an incorrect key entry. If the number of characters that have been misentered is greater than the number of allowable misentries, the misentry display means 203 indicates on the password entry screen that the password is incorrect.

If there is a misentry in the password that has been entered and the number of misentered characters is equal to or less than the number of allowable misentries, then the password reentry display means 204 displays a screen through which it is possible to reenter only the characters that have been misentered. If the number of characters that have been misentered is greater than the number of allowable misentries, the password reentry display means 204 displays a screen where the entire entered password has been cleared to allow the password to be reentered from the beginning.

The password and the number of allowable misentries can be set and changed on the copy initial settings screen. The number of allowable misentries can be two or more characters, but considering the implications of an incorrect key entry, it is preferable that it is three or less characters. For greater security it is particularly preferable that the number of allowable misentries is one character.

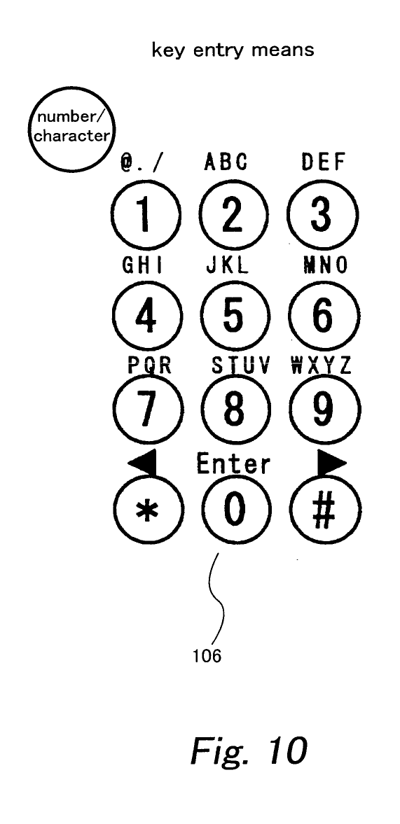

The key entry means of the present invention will be described next. As shown in FIG. 10, Roman characters have been set corresponding to the key entry means (10-key) 106 of the image processing device. When the “Number/Character” key on the upper left is operated, the function of the key entry means 106 is alternated between a 10-key and Roman character entry keys. If the 10-key has been switched to Roman character input keys, then for example when the “1” key is continuously operated, candidate characters are toggled in the manner of “@”→“/”→“.” →“@”. Similarly, when the “2” key is continuously operated, candidate characters are toggled in the manner of “A”→“B”→“C”→“A”. If a user wishes to select a candidate character, then he can select that character by operating a different key when the candidate character is displayed.

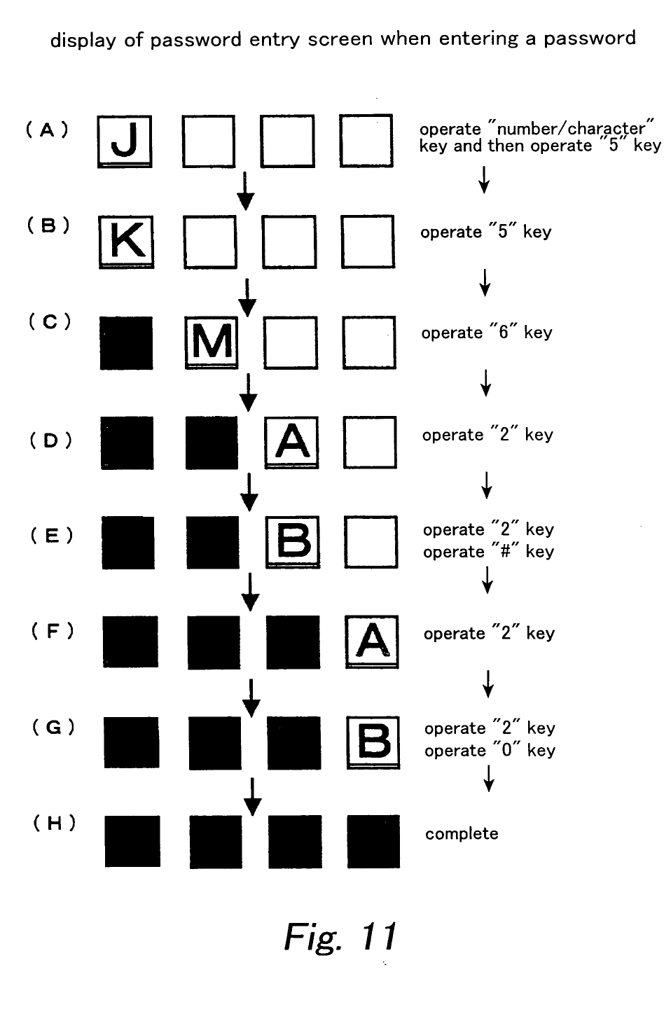

An example of entering a password into the password entry screen is described with reference to FIG. 11. To enter the password “KMBB,” first the “Number/Character” key is operated to switch to Roman character mode, and then the operation “5”→“5” is made on the 10-key to display “J”→“K” in that order within the field furthest left, as shown in (A) and (B) in FIG. 11. Next, when the “6” key is operated, the field furthest left is inverted to a black display, as shown in (C) of FIG. 11, and the letter “K” selected previously is not displayed in this field. Simultaneously, in the second field from the left the candidate character “M” is displayed. Next, as shown in (D) and (E) in FIG. 11, when the operation “2”→“2” is made on the 10-key, the second field from the left is inverted to a black display while “M” has been selected for this field but is not displayed, and “A”→“B” are displayed in that order in the third field from the left. Next, when “#” on the 10-key is operated, the third field from the left is inverted to a black display and for this field “B” is selected but is not displayed. Next, as shown in (F) and (G) in FIG. 11, when the operation “2”→“2” is made on the 10-key, “A”→“B” are displayed in that order in the fourth field from the left, and when “0” is operated on the 10-key, all the fields of the screen are inverted to black displays as shown in (H) of FIG. 11 and password entry is completed. During this series of operations the password display means 201 detects which keys are operated each time a key of the key entry means is operated and always displays characters as illustrated above.

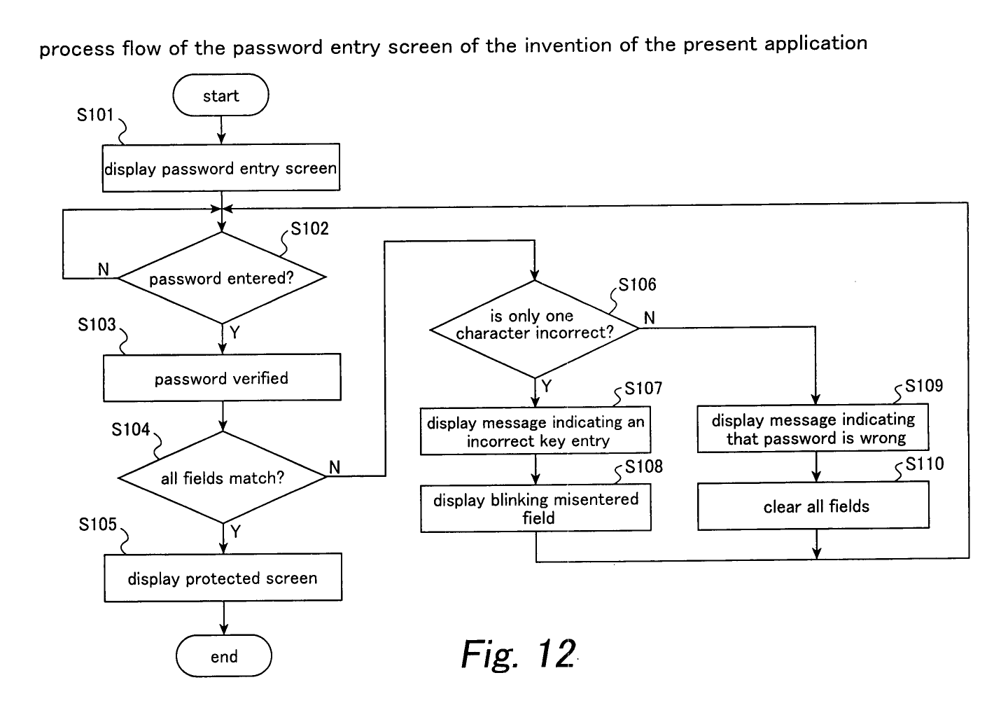

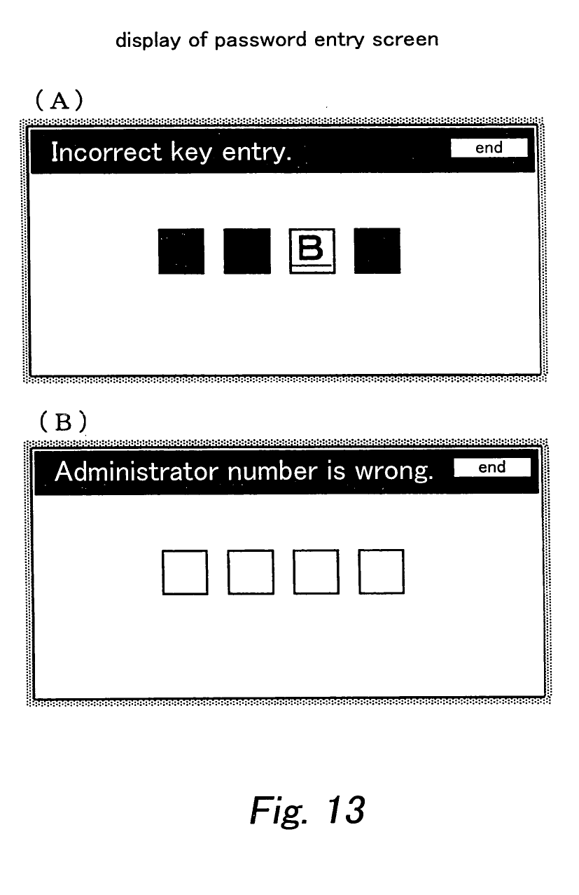

The process after a password has been input, which is a feature of the present invention, is described using the flowchart of FIG. 12 and (A) and (B) in FIG. 13, taking as an example a case where the copy initial settings screen of the multifunction device 1 is opened. Here, the number of allowable misentries has been set to 1. First, when the “copy initial settings” key on the left of the initial settings screen of FIG. 7 is operated to display the protected screen, a password entry screen such as that shown in FIG. 8 is displayed (S101). When a password (here, the administrator number) is entered on this screen using the key entry means 106 (S102), the password verification means 202 performs verification of the password that has been entered (S103). If the result of this verification is that all characters of the password are a match (S104), then the copy initial settings screen, which is the protected screen shown in FIG. 9, is displayed (S105) and the process is ended. If the result of the verification performed in S104 is that the characters do not match, then it is determined whether only one character does not match or whether two or more characters do not match (S106). If only one character does not match, then it is determined that this is the result of a simple incorrect key entry. As shown in (A) of FIG. 13, the misentry display means 203 displays “Incorrect Key Entry” to indicate that a simple incorrect key entry was made when entering the password (S107). Also, the password reentry display means 204 causes the incorrect field to flash so that a key entry can be made for only the incorrect field (S108), after which the procedure returns to S102. If in S106 two or more characters do not match, then, as shown in (B) of FIG. 13, the misentry display means 203 displays “Incorrect Administrator Number” to indicate that the password itself is incorrect (S109. The password reentry display means 204 clears the entire password that has been entered and the procedure is returned to S102.

It should be noted that the image processing device and program of the present invention are not limited to the specific example described above. For example, in the above example, fields with selected characters were displayed as inverted so that those characters are not shown, but it is also possible to substitute selected characters with symbols such as solid black circles (●) or letter Xs (X) to conceal the selected characters. Further, in the above example candidate characters were displayed during the selection of input characters, but it is also possible for these not to be displayed in order to increase security. In the above example, when there is an incorrect key entry of a single character, that character was displayed flashing as shown in (A) of FIG. 13. But it is also possible to not display this character and instead to display a flashing inverted display or symbol such as a solid black circle (●) or letter X (X) in order to increase security. Moreover, a case in which the password is entered through a 10-key was described in the above implementation, but other input devices such as a full keyboard, for example, can also be employed.

In the above implementation, a case where the image processing device of the present invention is a multifunction device serving as an image processing device was described as one example, but the present invention can be similarly adopted for other image processing devices as well, including electronic devices having a password entry screen, mobile devices such as portable telephones and PDAs, automatic cash teller machines, and personal computers.

The program of the present invention can be used incorporated into the above electric devices. Another possibility is for a computer that functions as a result of the program and a device having a password entry screen to be different. That is, the program of the present invention can also be capable of displaying a password screen provided by an Internet server, for example, on a terminal device such as a personal computer that is connected to a network. The program can be provided by various types of recording media such as CD-ROMs, DVDs, or flash memories, an electric communications line such as a LAN or a telephone line, or an optical communications network, for example.

The invention may be embodied in other forms without departing from the spirit or essential characteristics thereof. The embodiments disclosed in this application are to be considered in all respects as illustrative and not limiting. The scope of the invention is indicated by the appended claims rather than by the foregoing description, and all changes which come within the meaning and range of equivalency of the claims are intended to be embraced therein.

1. An image processing device having key entry means for entering a password and a password entry screen for displaying a screen protected by password, comprising:
entered password display means for controlling display of the password that is entered to the password entry screen;
password verification means for performing verification of a password that has been entered; and
misentry display means which, if there is a misentry in the password that has been entered and a number of characters of the misentry is equal to or less than a number of allowable misentries, indicates on the password entry screen that there is an incorrect key entry in the password, and if the number of characters that have been misentered is greater than a number of allowable misentries, indicates on the password entry screen that the password is incorrect.

2. The image processing device according to claim 1, further comprising:
password reentry display means which, if there is a misentry in a password that has been entered and a number of characters of the misentry is equal to or less than a number of allowable misentries, displays a screen through which it is possible to reenter only the characters that have been misentered, and if the number of characters that have been misentered is greater than a number of allowable misentries, displays a screen in which the entire entered password has been cleared to allow the password to be reentered from the beginning.

3. The image processing device according to claim 1,
wherein the entered password display means conceals the password that has been entered to the password entry screen.

4. The image processing device according to claim 1,
wherein the number of allowable misentries is one.

5. An image processing device having key entry means for entering a password and a password entry screen for displaying a screen protected by password, comprising:
entered password display means for controlling display of the password that is entered to the password entry screen;
password verification means for performing verification of a password that has been entered; and
password reentry display means which, if there is a misentry in the password that has been entered and a number of characters of the misentry is equal to or less than a number of allowable misentries, displays a screen through which it is possible to reenter only the characters that have been misentered, and if the number of characters that have been misentered is greater than a number of allowable misentries, displays a screen in which the entire entered password has been cleared to allow the password to be reentered from the beginning.

6. The image processing device according to claim 5,
wherein the entered password display means conceals the password that has been entered to the password entry screen.

7. The image processing device according to claim 5,
wherein the number of allowable misentries is one.

8. A program for causing a computer to function, with respect to an image processing device having key entry means for entering a password and a password entry screen for displaying a screen protected by password, as:
entered password display means for controlling display of the password that is entered to the password entry screen;
password verification means for performing verification of a password that has been entered; and
misentry display means which, if there is a misentry in the password that has been entered and a number of characters of the misentry is equal to or less than a number of allowable misentries, indicates on the password entry screen that there is an incorrect key entry in the password, and if the number of characters that have been misentered is greater than a number of allowable misentries, indicates on the password entry screen that the password is mistaken.

9. The program according to claim 8,
wherein the computer is made to function as password reentry display means which, if there is a misentry in the password that has been entered and a number of characters of the misentry is equal to or less than a number of allowable misentries, displays a screen through which it is possible to reenter only the characters that have been misentered, and if the number of characters that have been misentered is greater than a number of allowable misentries, displays a screen in which the entire entered password has been cleared to allow the password to be reentered from the beginning.

10. The program according to claim 8,
wherein the entered password display means conceals the password that has been entered to the password entry screen.

11. The program according to claim 8,
wherein the number of allowable misentries is one.

12. A program for causing a computer, with respect to an image processing device having key entry means for entering a password and a password entry screen for displaying a screen protected by password, to function as:
entered password display means for controlling display of the password that is entered to the password entry screen;
password verification means for performing verification of a password that has been entered; and
password reentry display means which, if there is a misentry in the password that has been entered and a number of characters of the misentry is equal to or less than a number of allowable misentries, displays a screen through which it is possible to reenter only the characters that have been misentered, and if the number of characters that have been misentered is greater than a number of allowable misentries, displays a screen in which the entire entered password has been cleared to allow the password to be reentered from the beginning.

13. The program according to claim 12,
wherein the entered password display means conceals the password that has been entered to the password entry screen.

14. The program according to claim 12,
wherein the number of allowable misentries is one.
